(19) United States
(12) Patent Application Publication
(10) Pub. No.: US 2003/0029809 A1
(43) Pub. Date: Feb. 13, 2003

(54) Apparatus for providing a red blood cell carrier

(76) Inventor: Anthony P. McHale, Coleraine (GB)

Correspondence Address: PALMER & DODGE, LLP, KATHLEEN M. WILLIAMS, 111 HUNTINGTON AVENUE, BOSTON, MA, 02199, US

(21) Appl. No.: 10/200,643

(22) Filed: Jul. 22, 2002

Related U.S. Application Data
(63) Continuation of application No. PCT/GB01/00429, filed on Feb. 1, 2001.
(63) Continuation of application No. PCT/GB00/03056, filed on Aug. 9, 2000.

(30) Foreign Application Priority Data
Feb. 8, 2000 (GB) 0002856.3

(51) Int. Cl. B01D 17/06; A01N 1/02

(52) U.S. Cl. 210/748; 210/85; 210/86; 210/321.78; 435/2

(57) ABSTRACT

We describe an apparatus for providing a red blood cell suitable for delivery of an agent to a vertebrate, the apparatus comprising: (a) a sensitisation means for sensitising a red blood cell to render it susceptible to disruption by an energy source; and (b) a loading means for loading the red blood cell with an agent, in which the loading means is separate from the sensitisation means and in fluid connection therewith.

### RELATED APPLICATIONS

This application is a Continuation of to PCT Application No. GB01/00429 filed Feb. 1, 2001 that claims priority to U.S. Provisional Application 60/181,796, filed Feb. 11, 2000, and to UK Application No. 0002856.3, filed Feb. 8, 2000 and to PCT Application No. GB00/03056 filed Aug. 9, 2000, the entirety of which is incorporated herein by reference.

This invention relates to the field of medical devices. In particular, the invention relates to an apparatus for processing a delivery vehicle suitable for delivery of an agent to a vertebrate.

In our International Patent Application No PCT/GB00/02848, incorporated by reference, we show that treatment of red blood cells with an electric field increases their sensitivity to disruption by exposure to an external stimulus, for example, ultrasound. Consequently, efficient unloading of therapeutic agents carried by red blood cells at a site of interest may achieved at lower exposures of ultrasound, reducing possible damage to normal red blood cells. Hypotonic dialysis is disclosed as a means of loading the red blood cell with agent to be delivered.

As described in detail in our International Patent Application PCT/GB00/03056 (incorporated by reference), pre-sensitisation of red blood cells by exposure to ultrasound or an electric field increases their loading capacity, so that they are able to take up larger amounts of the agent(s) to be loaded than otherwise.

The present invention seeks to provide apparatus for performing various combinations of pre-sensitisation, loading and sensitisation.

According to a first aspect of the present invention, we provide an apparatus for providing a red blood cell suitable for delivery of an agent to a vertebrate, the apparatus comprising: (a) a sensitisation means for sensitising a red blood cell to render it susceptible to disruption by an energy source; and (b) a loading means for loading the red blood cell with an agent; in which the loading means is separate from the sensitisation means and in fluid connection therewith.

Preferably, the loading means comprises means for loading the red blood cell by hypotonic dialysis. The loading means may comprise one or more hollow fibres. Preferably, the apparatus further comprises means for pre-sensitising the red blood cell to increase the amount of an agent which is loaded compared to a red blood cell which is not pre-sensitised. The pre-sensitisation means and the sensitisation means may be integral. Alternatively, the pre-sensitisation means and the sensitisation means are separate.

There is provided, according to a second aspect of the present invention, an apparatus for loading a red blood cell with an agent, the apparatus comprising: (a) a loading means for loading the red blood cell with an agent; and (b) pre-sensitisation means for pre-sensitising a red blood cell to increase the amount of an agent which is loaded compared to a red blood cell which is not pre-sensitised; in which the loading means is separate from the pre-sensitisation means and in fluid connection therewith.

Preferably, one or both of the sensitisation means and the pre-sensitisation means comprises means for electrosensitising the red blood cell. The sensitisation means may compriss a chamber for receiving the red blood cells, one or more walls of which are defined by electrodes to enable an electric field to be established within the chamber. Such a sensitisation means may comprise one or mole flow-through cuvettes. Alternatively, or in addition, the sensitisation means comprises one or more micropores. Preferably, the micropore comprises substantially tubular electrodes positioned to define a space capable of allowing passage of a red blood cell.

The apparatus may further comprise a resealing means capable of resealing the red blood cell subsequent to hypotonic dialysis. The apparatus may further comprise a monitoring means capable of determining the amount of agent which is loaded into the red blood cell. The apparatus may further comprise a feedback means adapted to receive a signal from the monitoring means and capable of altering one or more loading parameters to adjust the amount of agent loaded into the red blood cell.

We provide, according to a third aspect of the present invention a method for providing a red blood cell suitable for delivery of an agent to a vertebrate, the method comprising the steps of: (a) providing an apparatus according to the first aspect of the invention; (b) loading the red blood cell with an agent in the loading means of the apparatus; and (c) sensitising the red blood cell in the sensitising means of the apparatus.

As a fourth aspect of the present invention, there is provided a method for loading a red blood cell with an agent, the method comprising the steps of: (a) providing an apparatus according to the second aspect of the invention; (b) loading the red blood cell with an agent in the loading means of the apparatus; and (c) pre-sensitising the red blood cell in the pre-sensitising means of the apparatus.

We provide, according to a fifth aspect of the present invention, use of an electroporation apparatus for the sensitisation, or the pre-sensitisation of a red blood cell.

In certain of the embodiments of the invention, the apparatus provided here is capable of pre-sensitising and loading a red blood cell with an agent. In other embodiments, the apparatus is capable of pre-sensitising, loading and sensitising a red blood cell. Other embodiments provide for a loading and sensitisation device. The means for sampling, pre-sensitising, loading sensitising, washing, sealing, and monitoring red blood cells may usefully be provided in the form of modules, which may be present in the apparatus in any combination to enable it to perform various functions. Various combinations as described below are possible.

The modules may be in fluid connection with each other, by which term we intend to mean that fluid from one module is capable of flowing to another module, whether continuously or discontinuously. The flow of materials into and out of the modules may be controlled by valves. The valves may be of any design suitable to control the flow of material. Examples include, but are not limited to, manual valves, pneumatic valves, mass flow controllers, needle valves and solenoid valves. Preferably, at least some of the various modules present in the invention are electrically isolated from each other. This is important where products of any of the various steps which may include use of an electric field (for example, pre-sensitisation, sensitisation, etc) are fed directly into a patient. Electrical isolation of the relevant modules from the patient thus minimises the risk of electric shock to the patient. Electrical isolation may be achieved by the use of suitable insulated valves, as known in the art. Furthermore, the use of drip feeds, where fluid from one part of the system drips onto a receiving container, for example, under the influence of gravity, are also envisaged.

The device may be controlled by means of a microcomputer or other processor capable of executing programmed instructions. The software for the processor may be provided in read-only format (ROM), or may be re-programmed by storage in RAM, or external devices such as floppy discs, hard discs, CD-ROMs, flash-ROMs, etc. The computer or processor may include a keyboard or other input device for programming or otherwise controlling the device. The device may have a manual override, which may be in the form of control knobs, or alternatively, overrides may be in the form of keyboard input. Such a programmable device comprises means for programming the processor or otherwise to control the device. Preferably, the device is capable of acting under instructions from the microprocessor without the need for user intervention.

The modules may be configured and/or operated in a number of different ways:

(a) In a first embodiment of the invention the apparatus comprises a sensitisation module (S) and a loading module (L). The sensitisation module and loading module are in fluid connection with each other. The sensitisation module acts on the red blood cells to sensitise the cells such that the cells undergo lysis on the subsequent application of an energy field such as ultrasound. The loading module enables the cells to be loaded with an agent of interest. The sensitisation module may be placed before or after the loading module, such that the red blood cells are sensitised and subsequently loaded, or loaded and subsequently sensitised.

(b) In a second embodiment of the invention the apparatus comprises a pre-sensitisation module (P), a sensitisation module (S) and a loading module (L). The modules are in fluid connection with each other. The sensitisation and loading modules act on the red blood cells as described above and therefore may be connected to each other in any order. The pre-sensitisation means enables the red blood cells to be pre-sensitised so that the cells will subsequently undergo efficient loading, and must therefore be placed before the loading module. The modules may therefore be connected in the following order: S, P, L; P, S, L; and P, L, S.

(c) A third embodiment of the invention comprises a pre-sensitisation module and a loading module in fluid connection with each other. As noted above, the pre-sensitisation module acts on the red blood cells so that the cells will subsequently undergo efficient loading and is therefore placed before the loading module.

(d) In a fourth embodiment, the invention comprises a pre-sensitisation/sensitisation module (referred to here as a “bifunctional module”) and a loading module in fluid connection with each other. In this embodiment a single module is used to enable pre-sensitisation and sensitisation of the red blood cells. A number of ways of configuring the modules are available in this embodiment. In one option, the cells pass into the bifunctional module first for pre-sensitisation and then into the loading module for loading. After passing through the loading module the cells pas back into the bifunctional module for a second time, where sensitisation of the cells takes place.

A further option is to pass the cells into the bifunctional module for pre-sensitisation, then back through the bifunctional module for a second time for sensitisation. After exiting the bifunctional module for a second time the cells are then fed into the loading module for loading. The bifuntunctional module therefore acts to pre-sensitise the cells on the first pass and sensitise the cell on the second pass. The reverse configuration may also be used, in which the bifunctional module sensitises the cells the first time, and pre-sensitises the cells the second time. The cells are then loaded with agent in the loading module.

The apparatus may comprise an optional sampling means for preparing or providing the red blood cells to be processed, as described below.

The apparatus may further comprise an optional washing module, and/or an optional resealing module. Thus, one or both of the resealing and washing modules may be included in any of the configurations described above. These may be placed after the loading modules. Further resealing and/or washing modules may also be placed after the pre-sensitisation and sensitisation modules. Monitoring modules may also be used in any of the above-described combinations and in any positions in the apparatus. The configurations described by the embodiments (a) to (d) are by way of example only, further configurations, which are not described here to avoid repetition, may be easily envisaged by a skilled person.

Sampling Means

As noted above, the various embodiments of the apparatus may comprise a sampling means. The term “sampling” encompasses the collection of a source of red blood cells and the subsequent processing of that source to produce a solution of red blood cells suitable for further processing steps (e.g., pre-sensitisation, sensitisation, loading, etc). Typically, the solution of RBCs that is produced is buffered. Processing may comprise separation of the red blood cells from other component, such a serum, white blood cells, platelets, medium etc Processing may further comprise the addition of diluents and/or anticoagulants to the source. The term “sampling means” is to be understood to be any means that can perform “sampling” as described above.

The red blood cells may come from any suitable Source. The source of red blood cells may comprise, for example, whole blood or packed red blood cells suspended in a buffer solution. Where the source is whole blood, the sampling means may comprise any means capable of taking a sample of red blood cells from the body of a patient, as known in the art. For example, the sampling means may include a collection means such as a sterile collection device as known in the art, comprising a container for the collection of blood into a dedicated low volume blood bag (for example, 20 ml). Such bags are used routinely by Blood Services for 450 ml collections. The bag should be sterile and may contain a small quantity of anticoagulant (7:1ratio) and may be equipped with 16 gauge needle. The collection device may comprise a sampling port (suitable for a Becton-Dickenson Vacutainer) to take further small samples for testing and cross-matching purposes and a septum to allow interface with other components. Alternatively, a connection device such as that supplied by Terumo may be used. The collection means may be detachable from the device for collection offsite. Thus, for example, dedicated vacutainers may be employed as collection devices which may then be readily centrifuged. It would then be easy to remove either buffy-coat and plasma leaving red cells or to aspirate a known volume of red cells for further manipulation.

In highly preferred embodiments of the invention, the collection means comprises a self contained module, which may be disposable. This allows all manipulation to be carried out in a closed (or functionally closed system). The functionally closed system may comprise a kit which is isolated from the environment by for example the presence of microbial filters to render it essentially sterile. The closed system may comprise solutions or other required components.

Means of separating red blood cells from other components are also known, and include gravity, centrifugation devices, filtration devices, etc. The use of magnetic separation is also encompassed; thus, in this embodiment, magnetic beads or microbeads are coated with a molecule (such as an antibody), which is capable of binding to a crythrocyte antigen, such as a molecule present on the surface of a red blood cell The blood is then mixed with the magnetic particles, and a magnetic field applied to separate the beads/RBCs from the other components. Magnetic separation of red blood cells is described in detail in U.S. Pat. Nos. 4,910,148, 5.514,340, 5,567,326, 5,541,072, 4,988,618, 4,935,147, 6,132,607, 6,129,848 and 6,036,857.

Anti-coagulants are known in the art, and may for example be selected from a group that includes CPD, CPDA-1 and heparin. As noted above, the sampling device may comprise anticoagulants, which are mixed with the red blood cells on collection. The anticoagulants may be provided in solution, or in lyophilised form. Examples of suitable diluents are also known in the art, and may be selected from a group that includes saline, physiological buffers such as PBS or Ringer's solution, cell culture medium and blood plasma or lymphatic fluid.

A particular embodiment of a sampling means is described in further detail below.

Sensitisation Means

Some embodiments of the invention comprise a sensitisation means, which enables the sensitisation of the red blood cells to be achieved. The purpose of sensitisation is to facilitate the release of the contents of the red blood cells at a target site. A sensitised red blood cell will undergo lysis in response to an applied stimulus such as an energy field. An example of a suitable and preferred energy field for disruption of a red blood cell is, but not limited to, an ultrasound field.

The term “sensitisation” therefore encompasses the destabilisation of cells without causing fatal damage to the cells. The destabilisation may be achieved by applying an energy field to the cells. The energy field may for example be, but not limited to, an electric field. In a preferred embodiment of the invention sensitisation is caused by a momentary exposure of the cells to one or more pulses of high electric field strength (electrosensitisation). However, the term “sensitisation means” is to be understood to be any means that can perform any form of “sensitisation” as described above.

Accordingly, a sensitisation means may comprise means for establishing and exposing red blood cells to an electric field. In general, a sensitisation means comprises a chamber for receiving the red blood cells. An electrosensitisation means comprises one or more electrodes, which may be formed integral with one or more walls of the chamber. In a preferred embodiment, one or more walls of the chamber are defined by electrodes to enable an electric field to be established within the chamber.

The sensitisation means may take several forms, but is preferably in the form of one or more flow cells. For example, the sensitisation means may comprise a flow-through cuvette or a micropore. A flow-through cuvette may be in the form of a vessel or chamber that comprises one or more pairs of electrodes arranged so that red blood cells may flow between the electrodes. The electrodes impart an electric field on the red blood cells that sensitises the cells. The sensitisation means may further comprise one or more micropores through which red blood cells flow. The micropore may comprise a pair of electrodes arranged so that cells may flow between the electrodes. Typically, the electrodes in a micropore are separated by a gap which is less than the gap used in conventional flow-through cuvettes. The flow cell, micropore, etc, may be produced by nanofabrication techniques.

The sensitisation means may be of any suitable size, depending on the volume of red blood cells to be sensitised. For example, a sensitisation means may suitably be capable of containing 300 mls of diluted red blood cells, for example, or be larger or smaller depending on the application.

The sensitisation means may comprise a known electroporator. Examples of such electroporators include the Electro Cell Manipulator Model ECM 600R or ECM630, commercially available from Gentronics Inc., of Dan Diego, Calif., U.S.A, as well as a Gene Pulser I or II, made by Biorad. Other electroporation devices are known in the art.

In the present invention the electric field that sensitises the cells may be produced by a pulse generator. The pulse generator is preferably one capable of producing different waveforms. Examples of such waveforms are, but not limited to, multiple pulses, sequential pulses, double pulses, square waves, modulated square waves, exponential waves, sinusoidal waves, a unipolar oscillating pulse train or a bipolar oscillating pulse train. Preferably the application of the electric field is in the form of multiple pulses such as double pulses of the same strength and capacitance or sequential pulses of varying strength and/or capacitance.

The output of the pulse generator may be controlled manually, or by computer or microprocessor. The computer may be pre-programmed, or may accept instructions from a user. In the case when the computer accepts instructions from a user, it is preferred that the user enters the instructions using menu driven software via for example a touch sensitive screen. The software on the computer may furthermore have a fail-safe routine that does not accept erroneous instructions. The computer system may be an integral part of the apparatus or the apparatus may have a means for linking to an external computer or processor by, for example an RS232 interface.

In a preferred aspect of the present invention, the electric field has a strength of from about 0.1 kV/cm to about 10 kV/cm under in vitro conditions, more preferably from about 1.5 kV/cm to about 4.0 kV/cm under in vitro conditions. Most preferably, the electric field strength is about 3.625 kV/cm under in vitro conditions.

Preferably the electric field has a strength of from about 0.1 kV/cm to about 10 kV/cm under in vivo conditions (see WO97/49450). More preferably, the electric field strength is about 3.625 kV/cm under in vitro conditions.

Preferably the application of the electric field is in the form of multiple pulses such as double pulses of the same strength and capacitance or sequential pulses of varying strength and/or capacitance. A preferred type of sequential pulsing comprises delivering a pulse of less than 1.5 kV/cm and a capacitance of greater than 5 μF, followed by a pulse of greater than 2.5 kV/cm and a capacitance of less than 2 μF, followed by another pulse of less than 1.5 kV/cm and a capacitance of greater than 5 μF. A particular example is 0.75 kV/cm, 10 μF; 3.625 kV/cm, 1 μF and 0.75 kV/cm, 10 μF.

Preferably the electric pulse is delivered as a waveform selected from an exponential wave form, a square wave form and a modulated wave form.

As used herein, the term “electric pulse” includes one or more pulses at variable capacitance and voltage and including exponential and/or square wave and/or modulated wave forms.

In a particularly preferred embodiment, the following electrosensitisation protocol is used. Cells are then suspended at a density of 7×10⁸ cells/ml or lower and exposed to an sensitisation strategy involving delivery of two electric pulses (field strength=3.625 kV/cm at a capacitance of 1 μF) using an electrosentising means as described above. Cells are immediately washed with PBS containing MgCl₂ (4 mM) (PBS/Mg) and retained at room temperature for at least 30 min in the PBS/Mg buffer at a concentration of 7×10⁸ cells/ml t o facilitate re-sealing. Optionally, cells are subsequently washed and suspended at a concentration of 7×10⁸ cells/ml in PBS/Mg containing 10 mM glucose (PBS/Mg/glucose) for at least 1 hour.

Loading Means

As used herein, the term “loading” refers to introducing into a red blood cell at least one agent. Typically, the agent is loaded by becoming internalised into a red blood cell. Loading of a red blood cell with more than one agent may be performed such that the agents are loaded individually (in sequence) or together (simultaneously or concurrently). Loading is generally performed in a separate procedure to the “sensitising” procedure. The agents may be first admixed at the time of contact with the red blood cells or prior to that time. The term “loading means” is to be understood to be any means that can perform “loading” as described above. Thus, a loading means comprises in general means for bringing a red blood cell in contact with an agent to be loaded. According to a preferred embodiment of the invention, a loading means comprises a vessel or chamber allowing mixing of red blood cells with a buffer solution comprising the agent to be loaded. Preferably, the loading means is in a form which allows rapid exchange of red blood cells with agents to be loaded.

The loading may be performed by a procedure selected from the group consisting of iontophoresis, elestroporation, sonoporation, microinjection, calcium precipitation membrane intercalation, microparticale bombardment, lipid-mediated transfection, viral infection, osmosis, dialysis, including hypotonic dialysis, osmotic pulsing, osmotic shock, diffusion, endocytosis, phagocytosis, crosslinking to a red blood cell surface component, chemical crosslinking, mechanical perforation/restoration of the plasma membrane by shearing, single-cell injection or a combination thereof.

Sonoporation as a method for loading an agent into a cell is disclosed in, for example, Miller et al (1998), Ultrasonics 36, 947-952.

Iontophoresis uses electrical current to activate and to modulate the diffusion of a charged molecule across a biological membrane, such as the skin, in a manner similar to passive diffusion under a concentration gradient, but at a facilitated rate. In general, iontophoresis technology uses an electrical potential or current across a semipermeable barrier. By way of example, delivery of heparin molecules to patients has been shown using iontophoresis, a technique which uses low current (d.c.) to drive charged species into the arterial wall. The iontophoresis technology and references relating thereto is disclosed in WO 97/49450.

In a preferred embodiment of the invention, loading takes place by way of hypotonic dialysis. Thus, in a preferred embodiment the loading means comprises one or more dialysis devices. The dialysis devices may be conventional dialysis devices as known in the art. The dialysis devices work on the principle of “osmotic shock”, whereby the loading of the agents into the red blood cells is facilitated by the induction of sequential hypotonicity and recovery of isotonicity. The term “osmotic shock” is intended herein to be synonymous with the term “hypotonic dialysis” or “hypoosmotic dialysis”. An exemplary osmotic shock/hypotonic dialysis method is described in Eichler et al., 1986, Res. Exp. Med. 186: 407-412. In summary, washed red blood cells are suspended in 1 ml of PBS (150 mM NaCl, 5 mM K₂HPO₄/KH₂PO₄; pH 7.4) to obtain a hematocrit of approximately 60%. The suspension is placed in dialysis tubing (molecular weight cut-off 12-14,000; Spectra-Por) and swelling of cells obtained by dialysis against 100 ml of 5 mM K₂HPO₄/KH₂PO₄, pH 7.4 for 90 minutes at 4° C. Resealing is achieved by subsequent dialysis for 15 minutes at 37° C. against 100 ml of PBS containing 10 mM glucose. Cells are then washed in ice cold PBS containing 10 mM glucose using centrifugation.

The device may implement other osmotic shock procedures including the method described in U.S. Pat. No. 4,478,824. That method involves incubating a packed red blood cell fraction in a solution containing a compound (such as dimethyl sulphoxide (DMSO) or glycerol) which readily diffuses into and out of cells, rapidly creating a transmembrane osmotic gradient by diluting the suspension of red blood cell in the solution with a near-isotonic aqueous medium. This medium contains an anionic agent to be introduced (such as inosine monophosphate or a phosphorylated inositol, for example inositol hexaphosphate) which may be an allosteric effector of haemoglobin, thereby causing diffusion of water into the cells with consequent swelling thereof and increase in permeability of the outer membranes of the cells. This increase in permeability is maintained for a period of time sufficient only to permit transport of the anionic agent into the cells and diffusion of the readily-diffusing compound out of the cells. This method is of limited effectiveness where the desired agent to be loaded into cells is not anionic, or is anionic or polyanionic but is not present in the near-isotonic aqueous medium in sufficient concentration to cause the needed increase in cell permeability without cell destruction.

U.S. Pat. No. 4,931,276 and WO 91/16080 also disclose methods of loading red blood cells with selected agents using an osmotic shock technique. Therefore, the device may implement these techniques to enable loading of red blood cells in the present invention. An alternative osmotic shock procedure is described in U.S. Pat. No. 4,931,276 which is incorporated herein by reference, and the device may implement that method,

Alternatively, the loading means may comprise a means for microparticle bombardment of the red blood cells, as known in the art. Microparticle bombardment entails coating gold particles with the agent to be loaded, dusting the particles onto a 22 calibre bullet, and firing the bullet into a restraining shield made of a bullet-proof material and having a hole smaller than the diameter of the bullet, such that the gold particles continue in motion toward cells in vitro and, upon contacting these cells, perforate them and deliver the payload to the cell cytoplasm.

It will be appreciated by one skilled in the art that combinations of methods may be used to facilitate the loading of a red blood cell with agents of interest, and that the loading means may comprise means for accomplishing this. Likewise, it will be appreciated that a first and second agent, may be loaded concurrently or sequentially, in either order, into a red blood cell in the device of the present invention.

Preferably the loading means comprises a large surface area for equilibration of the agent with the contents of the red blood cells. Preferentially, the loading means provides for rapid buffer exchange. The loading means may comprise means for retaining the red blood cell while allowing buffer to be drained and replaced Preferably the loading means provides multiple chambers that may be used in parallel. Preferably a plurality of hollow fibres, optionally in the form of a cartridge, is used for loading. The use of hollow fibres facilitates rapid and homogeneous buffer exchange, thereby reducing loading times and providing enhanced control over the loading process. The use of a multiplicity of hollow fibres in the form of cartridges further enables the apparatus to operate in a continuous mode. Additionally the use of more than one hollow fibre cartridge allows several different agents or combination of agents to be loaded simultaneously. Agitation may be used in the dialysis devices to speed up the loading process. Methods of agitation are well known in the art, and the skilled person may readily adapt the device described in this invention to include an agitation means. Furthermore, the loading means may comprise temperature control means for maintaining a certain temperature.

In a highly preferred embodiments of the invention, the loading means comprises two or more compartments which are separated by a semi-permeable membrane. Semi-permeable membranes are known in the art, and include cellulose acetate, polyethylene and polypropylene. Thus, in one particular embodiment, the loading means comprises a container or bag with at least one semi-permeable surface, in which the red blood cells are retained. Such a container may take the form of a dialysis tubing, which may be restrained at each end by suitable means, for example, clips. The dialysis tubing may be suspended in a suitable container which holds an appropriate buffer or medium. Preferably, the container holding the medium is in a tubular form, for example, a tube or pipe, through which the medium may be passed.

Various loading modalities are possible, and a preferred method using hypotonic dialysis is described here. To load the red blood cells, red blood cells are placed in an isotonic buffer comprising agent to be loaded, within the dialysis tubing. The container holding the red blood cells (in this case, the dialysis tubing) is then exposed Lo a hypotonic environment. Dialysis occurs so that the red blood cells are exposed to gradual decreases in tonicity of the medium, thus forming pores on the erythrocyte membrane, and allowing agent to be loaded. The buffer is then exchanged for a isotonic buffer for rescaling. Where the external container is a tubular member, preferably a continuous or semi-continuous flow of medium is maintained This allows the maximum concentration gradient to exist across the semi-permeable membrane for maximum dialysis efficiency.

In another embodiment, the loading means comprises an inner tubular member within an outer tubular member, one of which carries red blood cells, and other of which carries the relevant medium or buffer. The interface comprises a semi-permeable membrane. Either the red blood cells or the medium, or both, may be in flow. For example, the red blood cells may flow in the inner tubular member, while a hypotonic/isotonic buffer flows in the outer tubular member. Dialysis and buffer exchange occurs as described above.

In a third embodiment, the loading means comprises a plurality of hollow fibres, through which medium flows. The hollow fibres are enclosed in a chamber in which red blood cells are suspended. Flow of medium through the hollow fibres allows rapid dialysis and loading of the red blood cells.

The loading means may be of any suitable size, depending on the volume of red blood cells to be sensitised. For example, a loading means may suitably be capable of containing 300 mls of diluted red blood cells, for example, or be larger or smaller depending on the application. Resealing of the red blood cells may optionally take place in a separate module, and such a resealing means is described in detail below.

Pre-Sensitisation Means

The pre-sensitisation means enables pre-sensitisation of the red blood cells to be achieved. The purpose of pre-sensitisation is to enhance the efficiency of loading of an agent into a red blood cell, compared to a red blood cell which has not been subject to pre-sensitisation. The term “pre-sensitisation” encompasses the destabilisation of cells without causing fatal damage to the cells. The pre-sensitisation may take the form of an electrosensitisation step, as described below. Alternatively, or in addition, the pre-sensitisation may be effected by the use of ultrasound. Other methods may be used to pre-sensitise cells and enhance loading efficiency. For example, electromagnetic radiation such as microwaves, radio waves, gamma rays and X-rays may be used. In addition, the use of chemical agents such as DMSO and pyrrolidinone may be envisaged. Furthermore, thermal energy may be imparted on the red blood cells to pre-sensitise them. This may be achieved by raising the temperature of the red blood cells by conventional means, by heat shock, or by the use of microwave irradiation. In general, any method which perturbation or destabilisation of the surface membrane of a red blood cell (optionally forming pores) is a suitable candidate for use as a pre-sensitisation step. Accordingly, a pre-sensitisation means according to the invention is any means for exposing red blood cells to any of the pre-sensitising agents, energy, forms, etc as described above.

In preferred embodiments of the invention, the pre-sensitising means comprises means for electrosensitising the red blood cells. According to this method, a momentary exposure of a cell to one or more pulses at high electric field strength results in membrane destabilisation. The strength of the electric field may be adjusted up or down depending upon the resilience or fragility, respectively, of the cells being loaded and the ionic strength of the medium in which the cells are suspended. The electrical parameters that cause efficient pre-sensitisation may be different to the electrical parameters that cause efficient sensitisation.

The pre-sensitisation means may take several forms, but is preferably in the form of one or more flow cells. For example, the pre-sensitisation means may comprise a flow-through cuvette or a micropore. A flow-through cuvette may be in the form of a vessel that comprises one or more pairs of electrodes arranged so that red blood cells may flow between the electrodes. The electrodes impart an electric field on the red blood cells that pre-sensitises the cells. A micropore may be in the form of a vessel through which red blood cells flow The micropore may comprise a pair of electrodes arranged so that cells may flow between the electrodes. Typically, the electrodes in a micropore are separated by a gap which is less than the gap used in conventional flow-through cuvettes. The flow cell, micropore, etc, may be produced by nanofabrication techniques.

In the present invention the electric field that pre-sensitises the cells may be produced by a pulse generator. The pulse generator is preferably one capable of producing different waveforms. Examples of such waveforms are, but not limited to, multiple pulses, sequential pulses, double pulses, square waves, modulated square waves, exponential waves, sinusoidal waves, a unipolar oscillating pulse train or a bipolar oscillating pulse train. Preferably the application of the electric field is in the form of multiple pulses such as double pulses of the same strength and capacitance or sequential pulses of varying strength and/or capacitance.

The output of the pulse generator may be controlled manually, or by computer or microprocessor. The computer may be pre-programmed, or may accept instructions from a user. In the case when the computer accepts instructions from a user, it is preferred that the user enters the instructions using menu driven software via for example a touch sensitive screen. The software on the computer may furthermore have a fail-safe routine that does not accept erroneous instructions. The computer system may be an integral part of the apparatus or the apparatus may have a means for linking to an external computer or processor by, for example an RS232 interface.

The pre-sensitisation means may comprise an electroporator as known in the art. Examples of such electroporators include those listed above for Sensitisation.

Monitoring Means

The fluid passing through any components of apparatus may be monitored to determine its composition. Any constituent of the fluid may be measured, but of particular interest are measurements of components which provide a measure of the loading efficiency of the apparatus, i.e., those that provide an indication of the amount of agent that has been loaded into the red blood cells. Accordingly, a monitoring means may be provided in the device to enable such measurements to be made.

The monitoring means may measure the composition of the fluid by “destructive” means, or by “non-destructive” means. An example of the former is direct sampling. For example, a sample of cells may be taken from the apparatus, lysed, and the amount of agent loaded measured directly. Monitoring may be done by any suitable means depending on the nature of the agent to be measured. Examples of non-destructive monitoring means include, but not limited to, chemical, spectroscopic, spectrophotometric, fluorometric, light scattering, pH, and conductivity measurements.

Alternatively, a monitoring device that is an integral part of the apparatus may be used to monitor the fluid composition. The monitoring device may be positioned within the apparatus so that fluid flows through, past or in contact with the monitoring device. Measurements made by light, for example, light scattering, spectrophotometry and spectroscopy are particularly suited to a monitoring device that is integral to the apparatus. If the total amount of agent added to a solution of red blood cells is known then by measuring the amount of agent remaining outside the red blood cells after loading provides a measurement of the amount of agent that has been loaded into the cells, enabling an assessment of loading efficiency to be made.

A further variable which may usefully be monitored is the number or percentage of red blood cells which survive the various processing stages carried out by the apparatus. To monitor this the quantity of lysed cells may be measured, for example using a conventional haemolysis detector. Heamolysis measurements may be conducted by means known in the art, for example, by spectrophotometric measurement of soluble haemoglobin concentration, scattering, etc. The haemolysis detector may be placed in the apparatus after one or all of the various modules that make up the apparatus. For example, the haemolysis detector may be placed after the sensitisation means, pre-sensitisation means or the loading means. Alternatively, a sample may be taken from the apparatus at any point for analysis by a haemolysis detector off-line.

The apparatus may further comprise a feedback means Any measurements that are made by the monitoring device where present may be used as a basis for adjusting the operating parameters of the apparatus. The adjustment may be made manually, to for example, the controls of the pulse generator or by turning a valve controlling the amount of a material entering or leaving the apparatus. For an on-line monitoring device an electrical signal corresponding to the measurement may be fed to the pulse generator, or to valves controlling the flow of material into and out of the apparatus, thereby forming a feedback system. It is envisaged that the electrical signal from an on-line monitoring device would be fed into a computer or microprocessor for processing. The computer or microprocessor would then send a resultant electrical signal to, for example, the pulse generator or to valves controlling flow of material.

Resealing Means

The term “resealing” encompasses the stabilisation of the membrane of a red blood cell by closing pores in the membrane that have previously been opened by some other process, for example, by a loading process such as hypotonic dialysis. Resealing may form part of the loading procedure, as described above.

Resealing may be facilitated by suspending the red blood cells in suitable resealing solution for a period of time. Accordingly, a resealing means according to the invention generally comprises any means for bringing the red blood cells with a suitable resealing buffer. For example, a resealing means may comprise a chamber which is capable of holding a suitable resealing medium, in which the red blood cells may be suspended. Furthermore, the resealing means may comprise temperature control means for maintaining a certain temperature. The resealing means may comprise a stirrer, or any other means of agitating the red blood cells to facilitate resealing. It will be appreciated that resealing may suitably take place within the loading means, the sensitisation means and/or the pre-sensitisation means. Thus, the buffer within any or all of these means may be exchanged with a suitable resealing medium. Thus, in some embodiments of the invention, the resealing means may comprise the loading means, the sensitisation means, and/or the pre-sensitisation means (i.e., the resealing means may be integral with each or all of these means).

The resealing solution may be chosen from for example from a group that includes physiological strength saline (i.e., isotonic saline), physiological buffers such as PBS or Ringer's solution, cell culture medium and blood plasma or lymphatic fluid. Each of these may optionally comprise Mg ions or glucose, for example, at 10 mM. The solutions may be provided as concentrates and diluted before use.

Washing Means

A device according to the invention may further comprise a washing means or cleaning means, which is capable of removing unwanted material from a solution of red blood cells. Typically, the unwanted material is one which is present in the medium in which the red blood cells are suspended. For example, such unwanted material may include salts, sugars, nucleic acids, polypeptides, urea, etc. The unwanted material may include for example, but not exclusively, lysed cells or excess agent. A particular material which may be desirably removed is haemoglobin, which may be released from the red blood cells during a loading procedure.

The unwanted material may be removed by washing the cells in a solution, for example physiological strength saline (i.e., isotonic saline), and physiological buffers such as PBS or Ringer's solution. The washing means may include means for separating the washing buffer from the red blood cells, for example, a centrifuge, one or more dialysis membranes, a column, or a filter. The washing means may comprise means for pulsed membrane filtration, or spinning membrane filtration. Other means of separation of the red blood cells from washing medium, for example, magnetic separation, are known in the art.

Agents

A variety of different agents may be loaded into the red blood cell using the device of the present invention. Preferred agents include those useful for imaging of tissues in vivo or ex vivo. For example, imaging agents, such as antibodies which arc specific for defined molecules, tissues or cells in an organism, may be used to image specific parts of the body by releasing them at a desired location using ultrasound. This allows imaging agents which are not completely specific for the desired target, and which might otherwise lead to more general imaging throughout the organism, to be used to image defined tissues or structures. For example, an antibody which is capable of imaging endothelial tissue may be used to image endothelial cells in lower body vasculature, for example, lower limbs, by releasing the antibody selectively in the lower body by applying ultrasound thereto.

As used herein, the term “agent” includes but is not limited to an atom or molecule, wherein a molecule may be inorganic or organic, a biological effector molecule and/or a nucleic acid encoding an agent such as a biological effector molecule, a protein, a polypeptide, a peptide, a nucleic acid, a peptide nucleic acid (PNA), a virus, a virus-like particle, a nucleotide, a ribonucleotide, a synthetic analogue of a nucleotide, a synthetic analogue of a ribonucleotide, a modified nucleotide, a modified ribonucleotide, an amino acid, an amino acid analogue, a modified amino acid, a modified amino acid analogue, a steroid, a proteoglycan, a lipid, a fatty acid and a carbohydrate. An agent may be in solution or in suspension (e.g., in crystalline, colloidal or other particulate form). The agent may be in the form of a monomer, dimer, oligomer, etc, or otherwise in a complex. The agent may be coated with one or more molecules, preferably macromoleucles, most preferably polymers such as PEG (polyethylene glycol). Use of a PEGylated agent increases the circulating lifetime of the agent once released.

The agent may be an imaging agent, by which term is meant an agent which may be detected, whether in vitro in the context of a tissue, organ or organism in which the agent is located. The imaging agent may emit a detectable signal, such as light or other electromagnetic radiation. The imaging agent may be a radio-isotope as known in the art, for example ³²P or ³⁵S or ⁹⁹Tc, or a molecule such as a nucleic acid, polypeptide, or other molecule as explained below conjugated with such a radio-isotope. The imaging agent may be opaque to radiation, such as X-ray radiation. The imaging agent may also comprise a targeting means by which it is directed to a particular cell, tissue, organ or other compartment within the body of an animal. For example, the agent may comprise a radiolabelled antibody specific for defined molecules, tissues or cells in an organism.

The imaging agent may be combined with, conjugated to, mixed with or combined with, any of the agents disclosed herein.

It will be appreciated that it is not necessary for a single agent to be used, and that it is possible to load two or more agents for into the vehicle. Accordingly, the term “agent” also includes mixtures, fusions, combinations and conjugates, of atoms, molecules etc as disclosed herein. For example, an agent may include but is not limited to: a nucleic acid combined with a polypeptide; two or more polypeptides conjugated to each other; a protein conjugated to a biologically active molecule (which may be a small molecule such as a prodrug); or a combination of a biologically active molecule with an imaging agent.

As used herein, the term “biological effector molecule” or “biologically active molecule” refers to an agent that has activity in a biological system, including, but not limited to, a protein, polypeptide or peptide including, but not limited to, a structural protein, an enzyme, a cytokine (such as an interferon and/or an interleukin) an antibiotic, a polyclonal or monoclonal antibody, or an effective part thereof, such as an Fv fragment, which antibody or part thereof may be natural, synthetic or humanised, a peptide hormone, a receptor, and a signalling molecule. Included within the term “immunoglobulin” are intact immunoglobulins as well as antibody fragments such as Fv, a single chain Fv (scFv), a Fab or a F(ab′)₂.

Preferred immunoglobulins, antibodies, Fv fragments, etc are those which are capable of binding to antigens in an intracellular environment, Known as “intrabodies” or “intracellular antibodies”. An “intracellular antibody” or an “intrabody” is an antibody which is capable of binding to its target or cognate antigen within the environment of a cell, or in an environment which mimics an environment within the cell.

Selection methods for directly identifying such “intrabodies” have been proposed, such as an in vivo two-hybrid system for selecting antibodies with binding capability inside mammalian cells. Such methods are described in International Patent Application number PCT/GB00/00876, hereby incorporated by reference. Techniques for producing intracellular antibodies, such as anti-β-galactosidase scFvs, have also been described in Martineau, et al., 1998, J Mol Biol 280, 117-127 and Visintin, et al., 1999, Proc. Natl. Acad. Sci. USA 96, 11723-11728.

An agent may include a nucleic acid, as defined below, including, but not limited to, an oligonucleotide or modified oligonucleotide, an antisense oligonucleotide or modified antisense oligonucleotide, cDNA, genomic DNA, an artificial or natural chromosome (e.g. a yeast artificial chromosome) or a part thereof, RNA, including mRNA, tRNA, rRNA or a ribozyme, or a peptide nucleic acid (PNA); a virus or virus-like particles; a nucleotide or ribonucleotide or synthetic analogue thereof, which may be modified or unmodified; an amino acid or analogue thereof, which may be modified or unmodified; a non-peptide (e.g., steroid) hormone; a proteoglycan; a lipid; or a carbohydrate. If the biological effector molecule is a polypeptide, it may be loaded directly into a red blood cell of the invention; alternatively, a nucleic acid molecule bearing a sequence encoding the polypeptide, which sequence is operatively linked to transcriptional and translational regulatory elements active in a cell at the target site, may be loaded. Small molecules, including inorganic and organic chemicals, are also of use in the present invention. In a particularly preferred embodiment of the invention, the biologically active molecule is a pharmaceutically active agent, for example, an isotope.

A preferred embodiment of the invention comprises a device suitable for loading a ribozyme or an oligonucleotide such as an antisense oligonucleotide into a red blood cell, which is optionally sensitised, for delivery into a target cell or tissue.

Particularly useful classes of biological effector molecules include, but are not limited to, antibiotics, anti-inflammatory drugs, angiogenic or vasoactive agents, growth factors and cytotoxic agents (e.g., tumour suppressers). Cytotoxic agents of use in the invention include, but are not limited to, diptheria toxin, Pseudomonas exotoxin, cholera toxin, pertussis toxin, and the prodrugs peptidyl-p-phenylenediamine-mustard, benzoic acid mustard glutamates, ganciclovir, 6-methoxypurine arabinonucleoside (araM), 5-fluorocytosine, glucose, hypoxanthine, methotrexate-alanine, N-[4-(a-D-galactopyranosyl) benyloxycarbonyl]-daunorubicin, amygdalin, azobenzene mustards, glutamyl p-phenylenediamine mustard, phenolmustard-glucuronlide, epinibicin-glucuronide, vinca-ceplhalosporin,phenylenediamine mustard-cephalosporin, nitrogen-mustard-cephalosporin, phenolmustard phosphate, doxorubicin phosphate, mitomycin phosphate, etoposide phosphate, palytoxin-4-hydroxyphenyl-acetamide, doxorubicin-phenoxyacetamide, melphalan-phenoxyacetamide, cyclophosphamide, ifosfamide or analogues thereof. If a prodrug is loaded in inactive form, a second biological effector molecule may be loaded into the red blood cell or the present invention. Such a second biological effector molecule is usefully an activating polypeptide which converts the inactive prodrug to active drug form, and which activating polypeptide is selected fiom the group that includes, but is not limited to, viral thymidine kinase (encoded by Genbank Accession No. J02224), carboxypepridase A (encoded by Genbank Accession No. M27717), α-galactosidase (encoded by Genbank Accession No. M13571), β-glucuronidase (encoded by Genbank Accession No. M 15182), alkaline phosphatase (encoded by Genbank Accession No. J03252 J03512), or cytochrome P-450 (encoded by Genbank Accession No. D00003 N00003), plasmin, carboxypepridase G2, cytosine deaminase, glucose oxidase, xanthine oxidase, β-glucosidase, azoreductase, t-gutamyl transferase, β-lactamase, or penicillin amidase. Either the polypeptide or the gene encoding it may be loaded; if the latter, both the prodrug and the activating polypeptide may be encoded by genes on the same recombinant nucleic acid construct. Furthermore, either the prodrug or the activator of the prodrug may be transgenically expressed and already loaded into the red blood cell according to the invention. The relevant activator or prodrug (as the case may be) is then loaded as a second agent according to the methods described here.

Preferably the biological effector molecule is selected from the group consisting of a protein, a polypeptide, a peptide, a nucleic acid, a virus, a virus-like particle, a nucleotide, a ribonucleotide, a synthetic analogue of a nucleotide, a synthetic analogue of a ribonucleotide, a modified nucleotide, a modified ribonucleotide, an amino acid, an amino acid analogue, a modified amino acid, a modified amino acid analogue, a steroid, a proteoglycan, a lipid and a carbohydrate or a combination thereof (e.g., chromosomal material comprising both protein and DNA components or a pair or set of effectors, wherein one or more convert another to active form, for example catalytically).

The invention will now be described by means of a description of various preferred non-limiting embodiments, with reference to the Figures, in which:

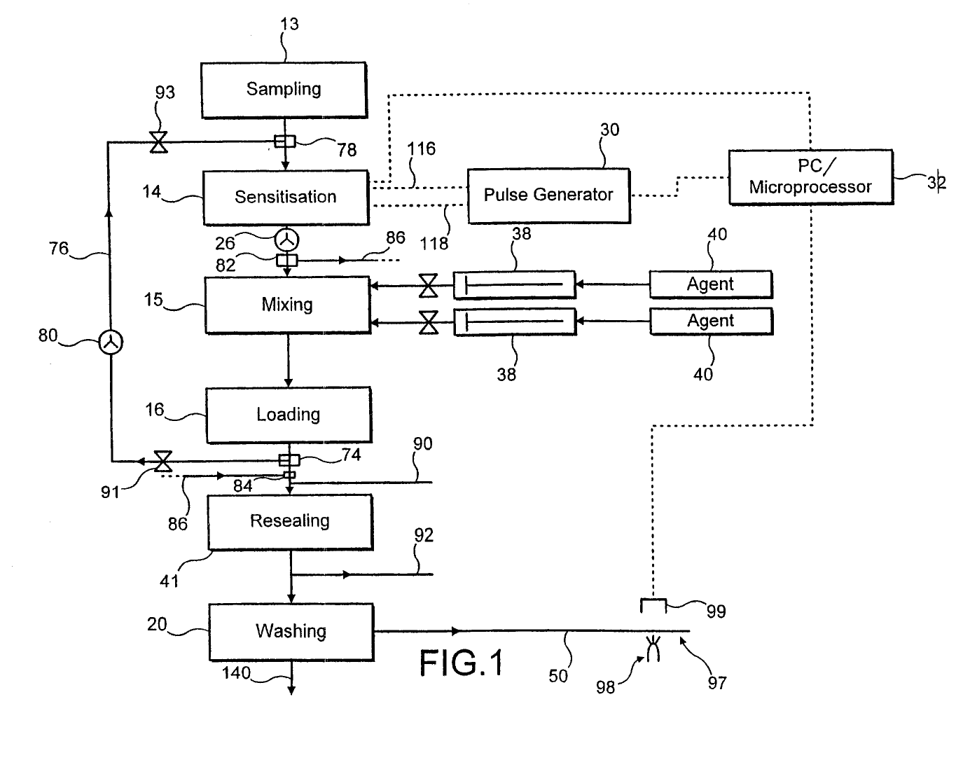

FIG. 1 shows a schematic diagram for an apparatus according to a first embodiment of the invention, comprising a sensitisation means and a loading means and a device according to a fourth embodiment of the invention, which comprises a pre-sensitisation/sensitisation means and a loading means;

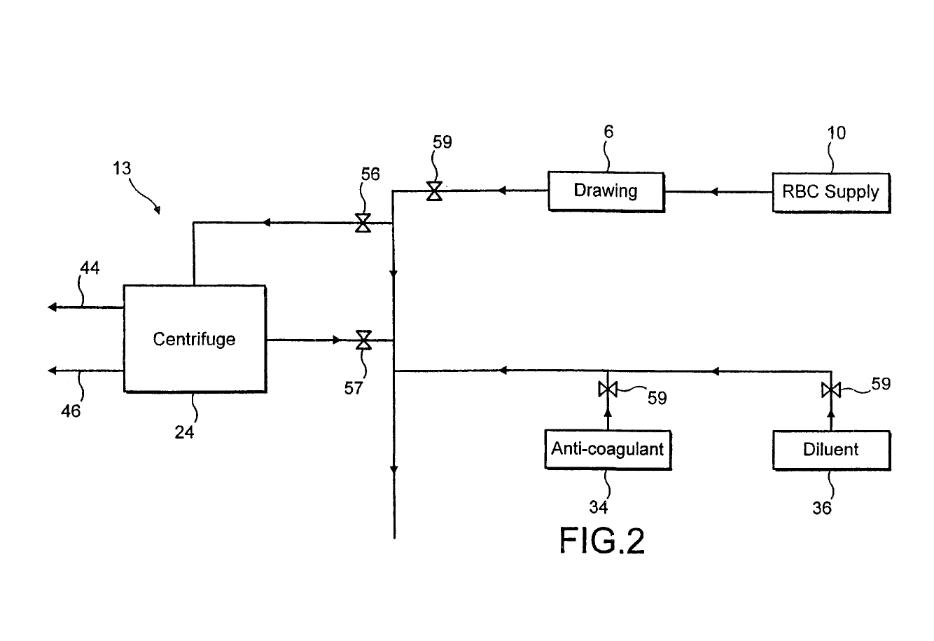

FIG. 2 shows a schematic diagram of a preferred embodiment of a sampling means for use in the invention,

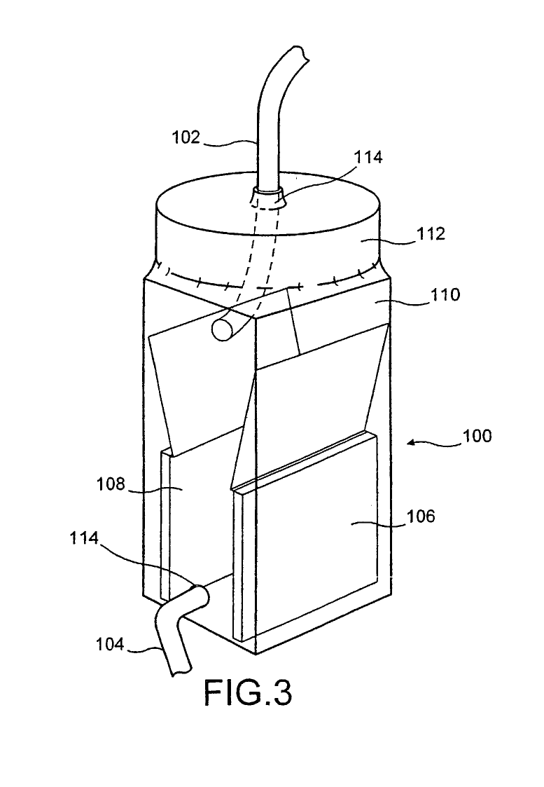

FIG. 3 shows a schematic diagram of a flow through cuvette for use in the invention;

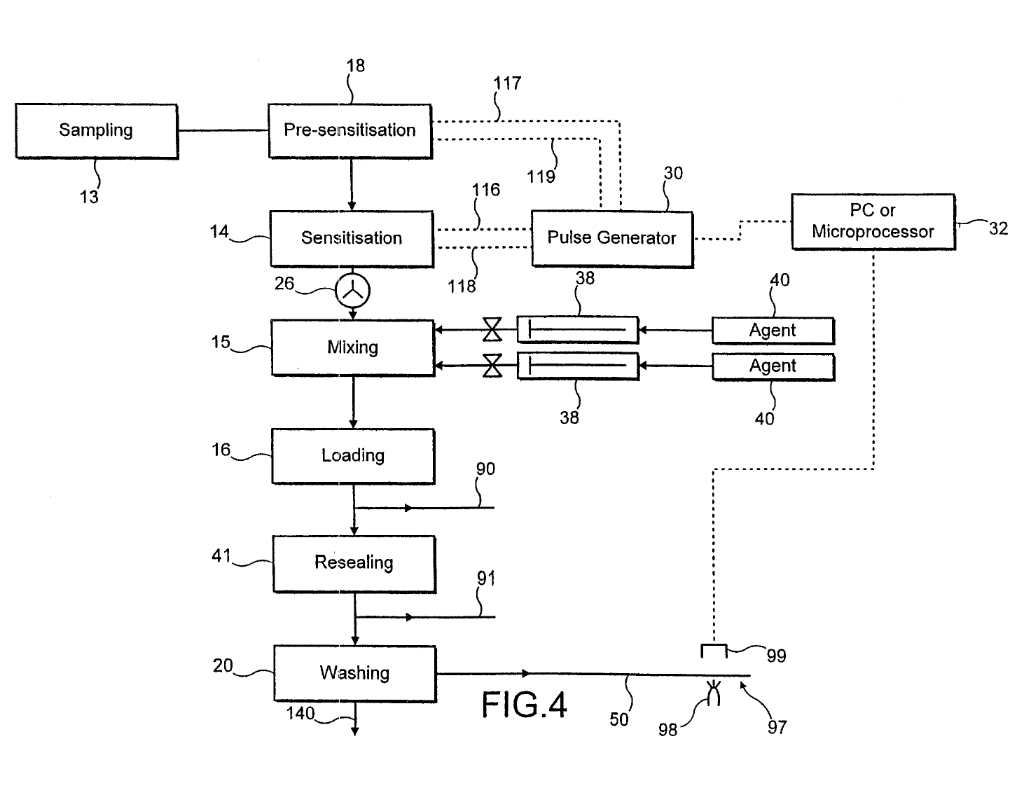

FIG. 4 shows a schematic diagram of an apparatus according to a second embodiment of the invention;

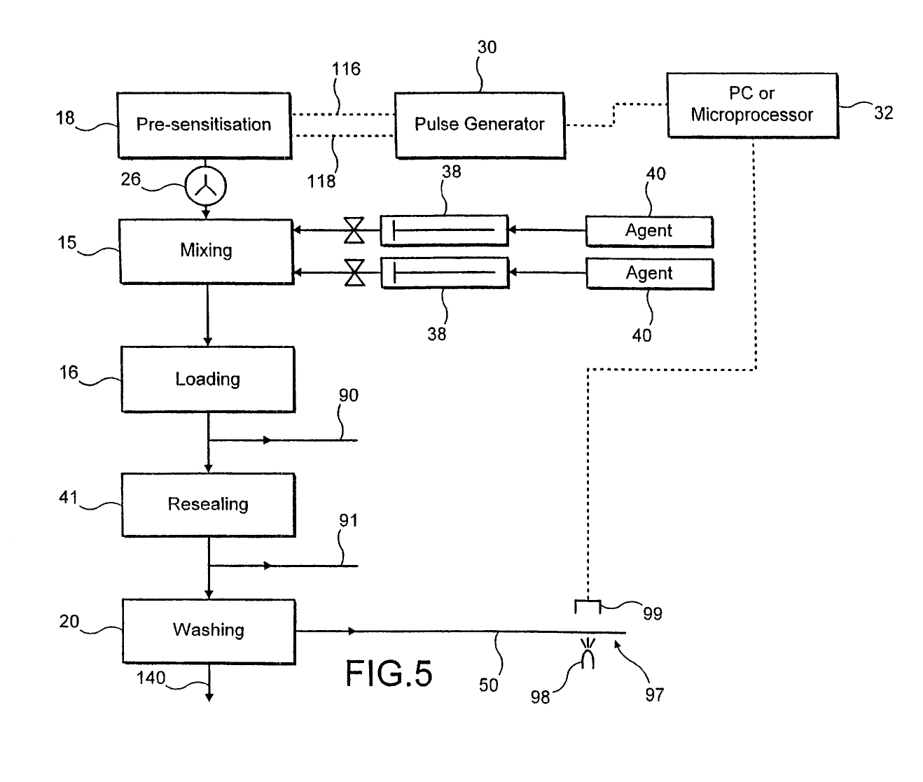

FIG. 5 shows a schematic diagram for an apparatus according to a third embodiment of the invention.

A schematic diagram of an apparatus according to a first embodiment of the invention is shown in FIG. 1. The apparatus comprises a sensitisation means and a loading means which are in fluid connection with each other. The connections between the various parts of the device, as described hereafter, may be by suitable IV tubing segments which are represented in the figures by single solid lines. Arrows on the single solid lines represent the direction of fluid flow through the IV tubing.

The sensitisation means 14 may comprise a temperature-controlled housing containing one or more means which are designed to impart an electrical field to the red blood cells that flow through the sensitisation means 14. The temperature-controlled housing may be maintained at a temperature that is either pre-set, set by a user, or set according to instructions from a microprocessor/computer 32. The red blood cells (optionally from a sampling means, as described below) flow into the sensitisation means 14 by gravity feed or under the influence of a peristaltic pump.

In a first example of the first embodiment the sensitisation means 14 comprises one or more flow-through cuvettes 100, which may be disposable. An illustration of a flow-through cuvette 100 is shown in FIG. 3. The cuvette chamber comprises a clear plastic rectangular housing defining an enclosure 10 having a opening at the upper end. A push-on cap 112 closes this opening. A tubing segment 102 extends snugly through a hole in the middle of the cap 112 that is sealed with a fitting 114. The end of the tubing segment 102 acts as an inlet for the cells into the cuvette 100. Tubing section 104 extends snugly through a hole situated at or near the bottom of the cuvette 100 and the hole is sealed with a fitting 114. The tubing section 104 acts as an outlet for the cells. The enclosure 110 is preferably moulded with a pair of embedded elongated electrodes 106 and 108 which are connected to cables 116 and 118 (shown in FIG. 1) that receive an electrical signal from a pulse generator 30. The electrodes 106 and 108 are uniformly spaced apart and extend parallel, substantially along the full length of the chamber, between the inlet and outlet to enable fluid to pass therebetween. The electrodes may be of any suitable conductive material such as stainless steel or aluminum and may be gold or platinum plated where desired. The electrodes may be disposable. Various profiles for the electrodes are possible, for example, crenellated, sinuous, etc. Such profiled electrodes have the advantage of increased electrode surface area, leading to more even field strength.

In a second example of the first embodiment the sensitisation means comprise a series of micropores. Each micropore comprises a tubular member or pore with electrodes positioned on either side. The electrodes are uniformly spaced apart and extend parallel, substantially the full length of the pore, between an inlet and an outlet to enable fluid to pass through the pore. The electrodes may comprise two concentric circular electrodes with fluid directed to flow between the electrodes. The gap between the electrodes is generally less than the gap between the electrodes of a flow-through cuvette. The electrode gap may be adjusted and for a particular voltage applied to the electrodes, the smaller the electrode gap the larger the electric field exerted on the cells that pass between the electrodes. By way of example only, an applied voltage of only 3.6 V and an electrode separation of 10 μm results in electric field of 3.6 kV/cm, which is an electric field strength that is capable of readily sensitising red blood cells. It will be appreciated that the use of micropores requires a low voltage and is especially amenable for use in a portable or battery operated device.

Different electrode gaps may be chosen according to the particular flow rate and protocol required by a user of the apparatus. The electrodes are connected to the pulse generator 30 by cables 116 and 118.

The pulse generator 30 (FIG. 1) is connected to a mains supply and provides electrical pulses to the electrodes of the sensitisation means 14 via the electrical cables 116 and 118. An exemplary pulse generator 30 is the Electro Cell Manipulator Model ECM 600R commercially available from Gentronics Inc., of Dan Diego, Calif., U.S.A. A BTX ECM630 electroporator may also be used. Another pulse generator which may be used is a Gene Pulser I or II, made by Biorad.

The pulse generator 30 may be controlled manually to deliver one or more pulses that have particular parameters. The parameters include the peak voltage, waveform, duration and frequency of the pulses and the duration and duty cycle of the pulse train. The pulse generator 30 is preferentially controlled by the microprocessor/computer 32. The microprocessor/computer 32 may be pre-programmed to control the pulse generator 30 to give a train of pulses with a particular set of parameters. Alternatively the microprocessor/computer 32 may be configured to allow a user to enter the parameters of the pulse train via an interactive touch sensitive screen.

The cells are fed from the sensitisation means 14 via a peristaltic pump 26 into a mixing means comprising a mixing chamber 15. Agents 40, are pumped into the mixing chamber 15 by one or more injection pumps 38. The agents 40 are in the form of dedicated IV packs containing a drug in an isotonic saline solution. The fluid containing the red blood cells and the agents 40 is then fed into a loading means 16. It will be appreciated that mixing may take place within the loading means, so that the use of a separate mixing means is obviated. In this embodiment, the agents are fed into the loading means and mixed with the red blood cells within the chamber.

The loading means 16 may comprise one or more conventional dialysis devices. A number of dialysis devices are known in the art and are commercially available. A general dialysis device may comprise a semipermeable membrane. The semipermeable membrane comprises pores; molecules having dimensions greater than the pole diameter remain within the dialysis, device whereas smaller molecules traverse the pores and emerge in the dialysate outside the dialysis device. The membrane may be composed of for example, but not limited to, cellulose acetate, polyethylene and polypropylene. As described above, the red blood cells may be suspended inside a suitably sealed dialysis tubing, and exposed to external medium to accomplish hypotonic dialysis.

Alternatively, and as described above, the loading means 16 may comprise one or more hollow fibres. If a small number of cells are required to be loaded then one or more single hollow fibres such as Spectra/Por hollow fibres as supplied by Spectrum Laboratories may be used. If a large number of cells are required to be loaded, then a hollow fibre cartridge which comprises a plurality of hollow fibres may be used. The number of hollow fibres within a hollow fibre cartridge is dependent on the throughput requirements of the user of the apparatus. An exemplary hollow fibre cartridge is one supplied by Serotec. Loading by hypotonic dialysis of the cells with the agent takes place in the hollow fibres and the hollow fibre cartridges. The loading means may further comprise means for regulating the flow of medium past the hollow fibre(s), as well as means for agitating the loading means to accomplish mixing.

For safety purposes, the apparatus of this and other embodiments may also include a bar-code reader to read the bar-codes on, for example, supplies of blood cells and drugs or other agents to ensure the integrity of those supplies.

Optionally the apparatus further comprises a sampling means 13. The sampling means provides a solution of red blood cells that is suitable to pass into the sensitisation means 14. An exemplary sampling means 13 is shown in FIG. 2 and comprises a supply of red blood cells 10, a drawing means 6, a centrifuge 24, an anti-coagulant reservoir 34, and a diluent reservoir 36. The blood supply 10 may be a bag or tube, optionally direct from a patient. The drawing means 6 receives red blood cells from the supply 10 of either whole blood or of red blood cells (which may be packed cells suspended in a buffer solution). The drawing means 6 is preferentially a sterile tube welder or a sterile docking means. The sterile docking means may be one that is commercially available, for example one as supplied by Terumo. In certain embodiments, the supply of whole blood may come directly from a patient, in which case the drawing means 6 is adapted to receive blood directly from the veins and/or arteries of a patient and may include suitable means, for example, a sterile needle.

For a supply 10 that comprises whole blood, the blood flows from the drawing means 6 into a centrifuge 24. The centrifuge 24 is connected parallel to the IV tubing that leads from the drawing means 6 by two T-shaped couplings (not shown). Solenoid valves 56 and 57 control whether or not blood from the supply 10 flows through the centrifuge 24. The centrifuge 24 separates the red blood cells from the white blood cells and other components in the whole blood. The white blood cells exit the centrifuge 24 through an outlet 44 and may be stored or discarded. Other waste materials from the whole blood exit the centrifuge 24 through an outlet 46 and may be discarded. A single outlet may be used for both white blood cells and other waste materials (i.e., outlets 44 and 46 may be combined).

The red blood cells, which may come from the centrifuge 24 or directly from the drawing means 6 (in the case of ready prepared red blood cells), may be diluted with a diluent from the diluent reservoir 36. If the red blood cells come from a supply that does not contain an anticoagulant, the cells are mixed with an anti-coagulant from the anticoagulant reservoir 34. The flow from the drawing means 6, the anti-coagulant reservoir 34 and the diluent reservoir 36 is controlled by solenoid valves 59 which in turn are controlled electronically by a microprocessor/computer 32.

Resealing of the red blood cells after loading by hypotonic dialysis may take place within the loading means by suitable buffer exchange, or via a separate resealing means, as described in detail above. An exemplary resealing means 41 is described here. The cells are fed from the loading means 16 into the resealing means 4, which comprises a vessel in which the red blood cells are mixed with a resealing buffer from a resealing buffer reservoir (not shown). The resealing buffer may comprise a salt solution, exemplary salt solutions including PBS containing MgCl₂ (for example at 4 mM) (PBS/Mg). Other examples of resealing buffers are known in the art, and are described in for example U.S. Pat. No. 6,074,605, however any buffer suitable for resealing may be used. The resealing means 41 retains the cells at a set temperature for set period of time. By way of example the cells may be rested at room temperature for at least 30 min in the resealing buffer at a concentration of 7×10⁸ cells/ml. However, the temperature, retention period and cell concentration may be set to be many different combination of values for optimal resealing as determined by the user of the apparatus. The apparatus comprises a connection 90, in the IV tubing connecting the loading means 16 to the resealing means 41. The connection 90 enables an option of removing the fluid containing the red blood cells from the apparatus for re-sealing off-line.

Optionally the apparatus further comprises a washing means 20 in fluid connection with the resealing means 41. The washing means 20 comprises a vessel that mixes the red blood cells with a washing buffer from a washing buffer reservoir (not shown). The washing buffer may comprise a salt solution, by way of example only, the washing buffer may be PBS/Mg containing 10 mM glucose (PBS/Mg/glucose). However any buffer suitable for the washing the cells may be used. The supernatant is removed from the washing means 20 via a waste outlet 50. Optionally, cells are subsequently suspended for a period of time. The cells may, for example, be suspended at a concentration of 7×10⁸ cells/ml for at least 1 hour. However, the concentration and period of suspension may be varied according to a particular protocol set by the user of the apparatus. Washing may also appropriately be done during or after loading or resealing of the red blood cells, as lysis of the red blood cells can take place during loading, and accordingly the device may comprise means to connect the loading means to the washing means for this purpose (not shown).

The washing means 20 where present may comprise any commercial available washing device as known in the art, such as those described in for example U.S. Pat. No. 6,074,605. The apparatus may have a connection 92 in the IV tubing connecting the resealing means 41 to the washing means 20. The connection 92 enables an option of removing the fluid containing the red blood cells from the apparatus for cleaning offline.

Optionally the device comprises a monitoring means 97, through which the supernatant in outlet 50 passes. The monitoring means 97 monitors the amount of agent in the supernatant by spectrophotometric means. The amount of agent that is in the supernatant provides a measure of the amount of agent that has been loaded into the red blood cells The monitoring means 97 comprises a light source 98 capable of emitting light of a suitable wavelength and a photodetector 99. The photodetector 99 generates a signal that varies in response to tile amount of agent in the supernatant. The signal is fed from the photodetector 99 to the microprocessor/computer 32, which responds to the signal by adjusting the operating parameters of the apparatus. The operating parameters could comprise, for example, the operating parameters of the pulse generator 30. The monitoring means 97, microprocessor/computer 32 and signal generator 30 therefore form part of a feedback system that regulates the amount of agent loaded into the cells.

After exiting the washing means 20 the red blood cells may either be re-suspended in a suitable buffer, for example, Sag-M and may enter directly into a patient via a port 140 (if the red blood cells are autologous) or stored for future use in a bar-coded pack containing Sag-M that is connected to port 140. The bar-coded pack contains a small sampling pack for cross matching and quality control purposes.

As noted above, sensitisation may occur before or after loading; accordingly, the sensitisation means and the loading means may be connected in either order.

FIG. 4 illustrates an apparatus according to a second embodiment of the invention. The apparatus comprises a pre-sensitisation means 18, a sensitisation means 14 and a loading means 16.

The pre-sensitisation means 18 comprises a temperature-controlled housing and one or more means designed to impart an electrical field on the cells that flow through the pre-sensitisation means 18. The temperature-controlled housing is maintained at a temperature that is either pre-set, set by a user, or set according to instructions from a microprocessor/computer 32. The pre-sensitisation means 18 may comprise one or more disposable flow-through cuvettes 100, and/or one or more micropores, each of which are described above in the first embodiment. A pulse generator 30 is connected to a means supply and provides electrical pulses to the pre-sensitisation means 14 via electrical cables 117 and 119. The pulse generator 30 may have the same construction as that described in the first embodiment. The pulse generator 30 is preferentially controlled by a microprocessor/computer 32 of the same construction as that described in the first embodiment.

Cells are fed from the pre-sensitisation means 18 into a sensitisation means 14 which may have the same construction as those described in the first embodiment. The pulse generator 30, supplies electrical pulses to the electrodes of the sensitisation means 14 via the electrical cables 116 and 118. Cells may be fed from the sensitisation means 14 via the peristaltic pump 26 into an optional mixing chamber 15. One or more agents 40 are pumped into the mixing chamber 15 by one or more injection pumps 38. The fluid is then fed into the loading means 16 of the same construction as that described in the first embodiment.

Optionally, the apparatus further comprises a sampling means 13 having the same construction as that described in the first embodiment. Optionally, the apparatus further comprises a resealing means 41 of the same construction as that described in the first embodiment. Optionally, the apparatus further comprises a washing means 20 of the same construction as that described in the first embodiment. Optionally, the apparatus further comprises a monitoring means 97 of the same construction as those described in the first embodiment. The supernatant may be removed from the washing means 20 via a waste outlet 50 and through the monitoring means 97. The apparatus may have ports 90 and 91 that allow the option for cells to be removed from the apparatus and respectively resealed or washed off-line.

FIG. 5 illustrates an apparatus according to a third embodiment of the invention. The apparatus comprises a pre-sensitisation means 18 and a loading means 16. Cells flow from the pre-sensitisation means 18 into the loading means 16 via a segment of IV tubing. The pre-sensitisation means 18, the loading means 16, and (where present, the mixing chamber 15) are of the same construction as those described in the previous embodiments. A device according to this embodiment may optionally comprise a sampling means 13, a resealing means 41, a washing means 20, a monitoring means, each as described previously. An apparatus according to this embodiment is capable of loading red blood cells with agent to high efficiency.

An apparatus according to a fourth embodiment of the invention comprises a sensitisation means 14 and a loading means 16. The fourth embodiment of the invention is now described in reference to the apparatus illustrated in FIG. 1.

The apparatus is constructed so that the red blood cells can pass through the sensitisation means 14 twice, as will be described in more detail below. The sensitisation means is used to both pre-sensitise the cells, as well as to sensitise the cells. When the cells pass through the sensitisation means 14 for the first time the sensitising means 14 acts to pre-sensitise the cells. When the cells pass through the sensitisation means 14 for a second time the sensitising means acts to sensitise the cells. The sensitisation means 14 comprises a temperature-controlled housing and one or more means designed to impart an electrical field on the red blood cells that flow through the sensitisation means 14. The temperature-controlled housing is maintained at a temperature that is either pre-set, set by a user, or set according to instructions from a microprocessor/computer 32. The sensitisation means may comprise one or more disposable flow-through cuvettes 100 and/or one or more micropores, as described above.

A pulse generator 30 is connected to a mains supply and provides electrical pulses to the sensitisation means 14 via electrical cables 116 and 1 18. The pulse generator 30 has the same construction as that described in the first embodiment. The pulse generator 30 is preferentially controlled by a microprocessor/computer 32 of the same construction as that described in the first embodiment. When cells enter the sensitisation means 14 for the first time (i.e., directly from sampling means 13), the PC/microprocessor 32 controls the pulse generator 30 so that signals to the sensitisation means 14 cause the sensitisation means to act to pre-sensitise the red blood cells. A peristaltic pump 26 connects the sensitisation means 14 to a mixing chamber 15. Cells are fed from the sensitisation means 14 via the peristaltic pump 26 into the mixing chamber 15. One or more agents 40 are pumped into the mixing chamber 15 by one or more injection pumps 38. The fluid is then fed into a loading means 16 Optionally, agents may be mixed with the red blood cells in the loading means itself.

The loading means 16 comprises cuvettes or hollow fibre cartridges 130, of the same construction as those described in the first embodiment. The IV tubing leading from the loading means 16 comprises a T-shaped coupling 74 that allows the cells to flow through an IV tubing segment 76 under the influence of a peristaltic pump 80. The IV tubing 76 is further connected via a T-shaped coupling 78 to the IV tubing leading into the sensitisation means 14. Cells flow through the IV tubing 76 and into the sensitisation means 14 for a second time. The T-shaped couplings 76 and 78 contain valves (not shown) that allow cells to flow only in the direction indicated above The IV tubing 76 contains solenoid valves 91 and 93 that are operable to stop fluid flowing through the IV tubing segment 76 if the cells have passed through the sensitisation means 14 only once.

When cells enter the sensitisation means 14 via IV tubing 76 (i.e., the cells are entering the sensitisation means for a second time), the PC/microprocessor 32 controls the pulse generator 30 so that signals to the sensitisation means 14 cause the sensitisation means 14 to act to sensitise the red blood cells.

After passing through the sensitisation means 14 for the second time the red blood cells enter a T-shaped coupling 82 that enables the cells to flow through an IV tubing segment 86 (shown in part only). The IV tubing segment 86 is further connected to a T-shaped coupling 84 which is on the IV tubing leading from the loading means 16. The IV tubing segment 86 contains solenoid valves (not shown). The solenoid valves are operated by the PC/microprocessor 32 to allow red blood cells to pass through the IV tubing segment 86. Therefore, when the cells have passed through the sensitisation means for a second time, the solenoid valves operate so that the cells by-pass the mixing chamber 15 and loading means 16.

A device according to this embodiment may optionally comprise a sampling means 13, a resealing means 41, a washing means 20, and/or a monitoring means, each as described previously.

Any or all of the various components of the apparatus in its embodiments, such as the IV tubing, and the flow-through cuvettes 100, etc are preferably made of easily sterizable material, such as plastic or metal, etc. Such material may be sterilized by, for example, heat, autoclaving, ethylene oxide, gamma irradiation, electron beams, etc.

Alternatively, or in addition, the components may be disposable. Thus, for example, a loading means comprising a cuvette may be made in a disposable form, for patient hygiene and safety. The components may be made and sold in disposable “sets”, comprising for example, a cuvette for loading, a sensitisation chamber (optionally with any of the other components of the device) which may be swapped into the apparatus for each use. The invention includes such kits and sets, and their use. Furthermore, the device according to the invention may be made and sold together with an ultrasound generating apparatus, preferably a portable ultrasound generator, in order to effect disruption of sensitised (and optionally loaded) red blood cells. The device according to the invention may also comprise an ultrasound generating means, as known in the art.

Each of the applications and patents mentioned above, and each document cited or referenced in each of the foregoing applications and patents, including during the prosecution of each of the foregoing applications and patents (“application cited documents”) and any manufacturer's instructions or catalogues for any products cited or mentioned in each of the foregoing applications and patents and in any of the application cited documents, are hereby incorporated herein by reference. Furthermore, all documents cited in this text, and all documents cited or referenced in documents cited in this text, and any manufacturer's instructions or catalogues for any products cited or mentioned in this text, are hereby incorporated herein by reference.

Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in molecular biology or related fields are intended to be within the scope of the following claims.

1. An apparatus for providing a red blood cell suitable for delivery of an agent to a vertebrate, the apparatus comprising:
(a) a sensitisation means for sensitising a red blood cell to render it susceptible to disruption by an energy source; and
(b) a loading means for loading the red blood cell with an agent
in which the loading means is separate from the sensitisation means and in fluid connection therewith.

2. An apparatus according to claim 1, in which the loading means comprises means for loading the red blood cell by hypotonic dialysis.

3. An apparatus according to claim 1 in which the loading means comprises one or more hollow fibres.

4. An apparatus according to claim 1, further comprising means for pre-sensitising the red blood cell to increase the amount of an agent which is loaded compared to a red blood cell which is not pre-sensitised.

5. An apparatus according to claim 4, in which the pre-sensitisation means and the sensitisation means are integral.

6. An apparatus according to claim 4, in which the pre-sensitisation means and the sensitisation means are separate.

7. An apparatus for loading a red blood cell with an agent, the apparatus comprising:
(a) a loading means for loading the red blood cell with an agent; and
(b) pre-sensitisation means for pre-sensitising a red blood cell to increase the amount of an agent which is loaded compared to a red blood cell which is not pre-sensitised.
in which the loading means is separate from the pre-sensitisation means and in fluid connection therewith.

8. An apparatus according to claim 1, in which one or both of the sensitisation means and the pre-sensitisation means comprises means for electrosensitising the red blood cell.

9. An apparatus according to claim 8, in which the sensitisation means comprises a chamber for receiving the red blood cells, one or more walls of which are defined by electrodes to enable an electric field to be established within the chamber.

10. An apparatus according to claim 9, in which at least one electrode has a crenellated or sinusoidal cross sectional profile.

11. An apparatus according to claim 9, in which the sensitisation means comprises one or more flow-through cuvettes.

12. An apparatus according to claim 9, in which the sensitisation means comprises one or more micropores.

13. An apparatus according to claim 12, in which the micropore comprises substantially tubular electrodes positioned to define a space capable of allowing passage of a red blood cell.

14. An apparatus according to claim 1, further comprising a resealing means capable of resealing the red blood cell subsequent to hypotonic dialysis.

15. An apparatus according to claim 1, further comprising a monitoring means capable of determining the amount of agent which is loaded into the red blood cell.

16. An apparatus according to claim 1, further comprising a feedback means adapted to receive a signal from the monitoring means and capable of altering one or more loading parameters to adjust the amount of agent loaded into the red blood cell.

17. A method for producing a red blood cell suitable for delivery of an agent to a vertebrate, the method comprising the steps of:
(a) providing an apparatus according to claim 1,
(b) loading the red blood cell with an agent in the loading means of the apparatus; and
(c) sensitising the red blood cell in the sensitising means of the apparatus.

18. A method for loading a red blood cell with an agent, the method comprising the steps of:
(a) providing an apparatus according to claim 7,
(b) loading the red blood cell with an agent in the loading means of the apparatus; and
(c) pre-sensitising the red blood cell in the pre-sensitising means of the apparatus.
